(19) United States
(12) Patent Application Publication
(10) Pub. No.: US 2022/0172124 A1
(43) Pub. Date: Jun. 2, 2022

(54) GENERATING DATA SLICES FOR MACHINE LEARNING VALIDATION

(71) Applicant: International Business Machines Corporation, Armonk, NY (US)

(72) Inventors: Orna Raz, Haifa (IL); Marcel Zalmanovici, Kiriat Motzkin (IL); Eitan Daniel Farchi, Pardes Hanna-Karkur (IL); Raviv Gal, Kamon (IL); Avi Ziv, Haifa (IL)

(21) Appl. No.: 17/109,259

(22) Filed: Dec. 2, 2020

(51) Int. Cl. G06N 20/20

(52) U.S. Cl. CPC G06N 20/20; G06N 5/003

(57) ABSTRACT

A system and method for generating data slices for validating a classifier and validating the classifier. The classifier is trained using a training data set to train the underlying machine learning algorithm. Data is passed through the trained classifier to obtain results. The results are scored to determine the likelihood that the classifier correctly classified the data. Features are identified in the data set that can be used to validate the classifier. Based on the identified features at least one data slice in the data set is identified. The classifier is validated using the at least one data slice.

### BACKGROUND

The present disclosure relates to validating a model developed by machine learning, and more specifically generating data slices for machine learning validation utilizing automated tag generation and rule extraction from sets of data records.

Validating a machine learning algorithm used by a classifier, regression task or similar systems requires identifying the requirements in terms of the data space the algorithm is expected to work on, as well as identifying weaknesses over this data space. However, identifying the data that should be used for validation is often time consuming and difficult.

### SUMMARY

Embodiments of the present disclosure are directed to a system for generating data slices for validating a machine learning algorithm. The system includes a classifier configured to classify a data set according to a set of rules and a scorer configured to calculate a likelihood that the classifier has produced a correct result. The system further includes a feature identifier configured to identify features in the data set that can be used for validating the classifier. A rule generator is provided that is configured to identify a data subset of the data set that can be used to validate the classifier based on the features identified by the feature identifier as a data slice.

Embodiments of the present disclosure are directed to a computer implemented process for validating a classifier. The classifier is trained using a training data set to train the underlying machine learning algorithm. Data is passed through the trained classifier to obtain results. The results are scored to determine the likelihood that the classifier correctly classified the data. Features are identified in the data set that can be used to validate the classifier. Based on the identified features at least one data slice in the data set is identified. The classifier is validated using the at least one data slice.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating components of a system for automatically generating rules or data slices from subsets of records of a data set according to embodiments.

FIG. 2 is a flow diagram illustrating a process for validating a classifier trained using machine learning according to embodiments.

FIG. 3 is a block diagram illustrating a computing system according to one embodiment.

FIG. 4 is a diagrammatic representation of an illustrative cloud computing environment.

FIG. 5 illustrates a set of functional abstraction layers provided by cloud computing environment according to one illustrative embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relates to validating a model developed by machine learning, and more specifically generating data slices for machine learning validation utilizing automated tag generation and rule extraction from sets of data records. While the present disclosure is not necessarily limited to such applications, various aspects of the disclosure may be appreciated through a discussion of various examples using this context.

There can be various sources for the data slices ranging from user provided input based on their knowledge of the domain to be trained to automatically extracted ranges of continuous valued features. When validating a machine learning algorithm, it is necessary to identify the requirements in terms of the data space the algorithm is expected to work on as well as identifying weaknesses of the algorithm over the data space.

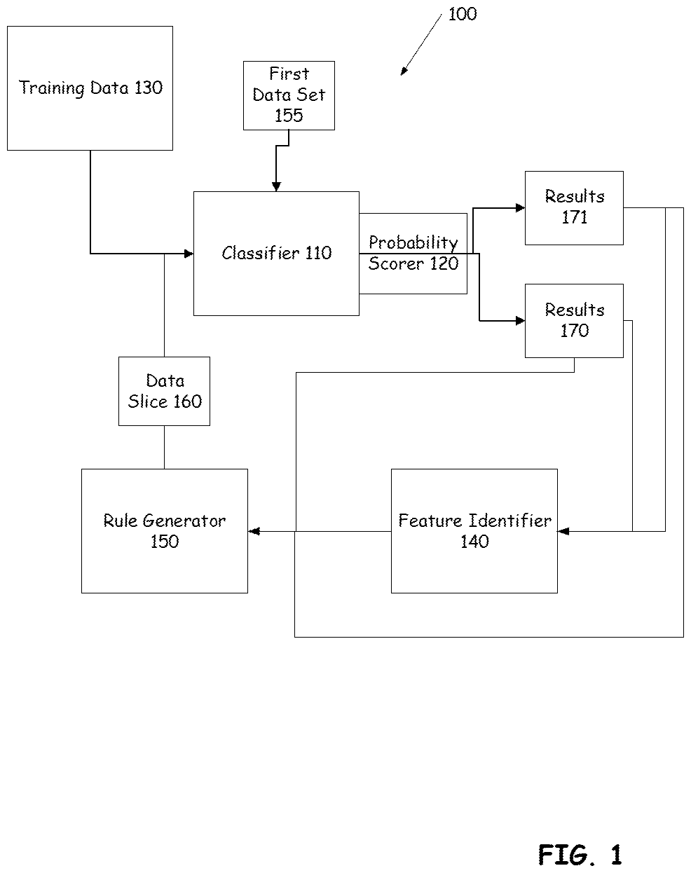

FIG. 1 is a block diagram illustrating components of a system for automatically generating rules or data slices from subsets of records of a data set. System includes a classifier 110, a scorer 120, a set of training data 130, a feature identifier 140, and a rule generator 150. While the present discussion discusses the validation of a classifier that uses a machine learning algorithm, it should be recognized that the present disclosure can be implemented on any system to validate a machine learning algorithm.

The classifier 110 is a component of the system that is configured to classify a data set according to a set of rules. The set of rules that are used by the classifier 110 are designed to look at the data set that is input and each feature of the data set and determine a particular output based on the combination of the features of the data set. For example, the classifier 110 may be configured to determine if a transaction is a valid transaction. In this instance each of the features that appear in the data set provide information to the classifier 110 as to if the transaction is or is not valid. The classifier 110 is trained using training data 130 that has features in the training data 130 that should result in a particular result from the classifier 110. The more training data 130 that is processed through the classifier 110 the more the classifier 110 is able to tune or modify the rules that are used to generate a particular output. The classifier 110 can use any rules or processes available to classify or otherwise produce the output from the input data, such as training data 130, and first data set as input and results 170 and 171 are output. The rules used by the classifier 110 can in some embodiments include some of the validating rules that were used to create data slices (as discussed below). In some embodiments the validating rules are added to the classifier 110 to improve the learning algorithm used by the classifier 110.

The output 170/171 of the classifier 110 can simply contain the determined result. That is, for example, in the case of a fraud transaction that the transaction is fraud or is not fraud. However, in some embodiments the output also includes a probability that the determination by the classifier 110 is in fact correct. To obtain the probability the classifier 110 passes the output through a scorer 120. The scorer 120 can be part of the classifier 110 or it may be a separate component of the system. The scorer 120 is configured to calculate the likelihood that the classifier 110 has produced the correct result. Alternatively, the scorer 120 is configured to identify the portion of the results that caused the classifier 110 to classify the result in the manner that it did. For example, if the classifier 110 merely outputs a score for the classification and that score is compared to a rule for the decision, the scorer 120 can calculate the delta between the determined score and the score needed to cause the decision to be made. The scorer 120 can use any method, process or means for calculating the probability or score.

The set of training data 130 is a set of data that is used to train the classifier 110. The training data 130 has a number of data sets that are designed to produce a first result and a number of data sets that are designed to produce a second result. Depending on the intent of the classifier 110 there may be more training data 130 data sets that are designed to produce different results. This can occur, for example, in certain types of medical data where certain features can indicate one result, but a slight change in one or more of the features could result in many different conclusions. Each of the data sets in the training data 130 has a number of features that are present in the data set that help cause the data set to cause the classifier 110 to report the particular data set in a particular way. By passing each of the training data sets through the classifier 110 the classifier 110 is able to become calibrated to the specific data results that the user or other organization desires.

The feature identifier 140 is a component of the system configured to identify features in the training data 130 that can be used for validating the classifier 110. In some embodiments the feature identifier 140 uses auto-validation features. Auto-validation features are features that are automatically defined based on data modality, and are used as tags over the records in the data set. The tags that are identified may not be useful for the training of the classifier 110, but may affect the learning of the classifier 110. However, these tags can be useful for validating the classifier 110. To identify these tags/features different analysis of the data set can be done depending on the type of data that is used for the training data 130. For example when the training data 130 is text then a dictionary can be used to generate the features. Using the dictionary the feature identifier 140 can identify for each entry multiple auto-validation features such as Word count, word length bin (short, med, high), dictionary word vided dictionary, dictionary word length bin (short, med, high), etc. If the data is images example tags used as validation features can include simple size info such as width and height, resolution, compression loss rate (e.g., for jpg), estimations of blurriness, contrast, amount of image taken by object to classify vs. rest of image, etc. For voice data example tags can include voice wave high/med/low frequency ranges.

Further the feature identifier 140 can use any available meta data as tags. For example, clinical data for people associated with x-ray images that are the input training data 130. This meta data may not be detailed or accurate enough for training, but may be useful for validation. It is also useful to abstract over the training data 130, such as to divide continuous feature values in bin (e.g., lowest 25%, highest 25%, the rest).

The rule generator 150 is a component of the system that is configured to identify candidates from within the training data 130 that can be used to validate the classifier 110. In some embodiments, the rule generator 150 uses problematic candidates from within the training data 130. Problematic candidates are those records in the data set that are provided with the intent of challenging the machine learning employed by the classifier 110. These candidates are often those data points that the classifier 110 has misclassified. In some embodiments, these candidates can be determined as a result of running an external analysis on the training data 130 or based on information provided by an individual who has knowledge of the data in the training data 130. Other approaches to identify these subsets of candidates can include active learning that is based on the confidence determined by the scorer 120, boosting algorithms, or identifying noisy labels in the data set. Noisy labels are those labels where the label provided with the data is incorrect. For example, identical or nearly identical inputs have a different output. In such cases, the scorer 120 can identify results with both high confidence and low confidence that the correct decision was made by the classifier 110.

The rule generator 150 divides the training data 130 into one or more data slices. The rule generator 150 separates the training data 130 between a particular subgroup and the rest of the data. In one embodiment the rule generator 150 uses a random forest model as the rule to identify the candidates for the subgroup using linear separation between the data in the training data 130. For example, the rule generator 150 can look for a specific amount of linear separation between a particular feature (e.g. tags identified by the feature identifier 140) in the data set. Using this model the rule generator 150 can determine if the particular feature is significant or not. If the rule generator 150 is unable to determine that the feature is significant, then no data slice 160 or rule will be made for that particular feature or data set. In some embodiments the rule generator 150 employs a polynomial rank separation. This can be based on input from a user who has semantic knowledge about the training data 130 or input from data quality metrics that look for the minimal separation rank that applies to a give data set. However, the rule generator 150 can use any number of algorithms to find a particular type of separation. These types of separation can include linear separation, non-linear separation, radial separation, etc.

When the rule generator 150 is creating more than one slice the rule generator 150 can take all of the misclassified data points and cluster them into groups. Ideally the maximum number of clusters would be small. i.e. less than 10. However, any number of clusters can be used. Each cluster of data points is then processed through the rule generator 150 in a similar manner as a single slice discussed above. That is if the separation of the data points in the cluster indicate a particular feature in the cluster is significant a slice will be made. Otherwise no slice will be made for that cluster.

One embodiment can use a gray box approach to capture potential weaknesses of the classifier 110′s training and generalize from that to data characteristics in terms of feature space over which the classifier 110 might be under performing. For example, it is powerful to be able to characterize records over which the classifier 110 has an especially high confidence or an especially low confidence. It is further useful to check if these are associated with higher than expected error concentration.

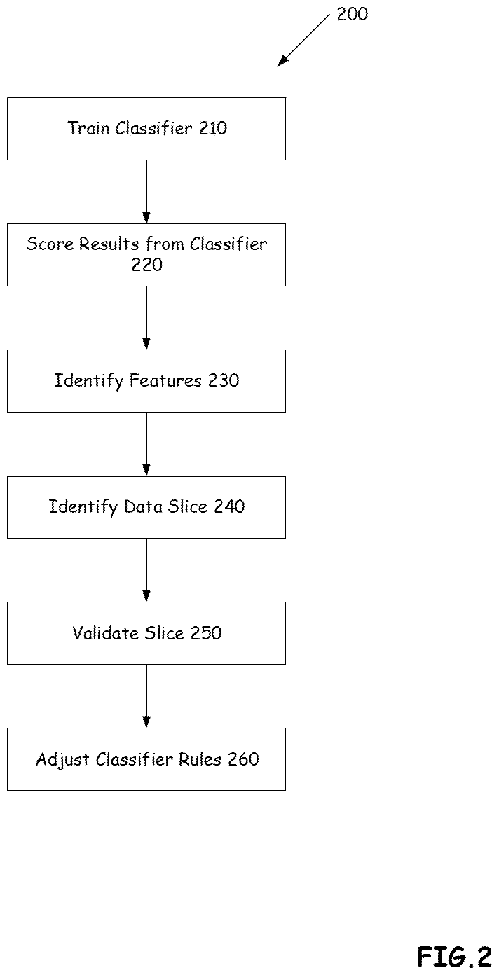

FIG. 2 is a flow diagram illustrating a process for validating a classifier 110 trained using machine learning. The process begins by training the classifier 110. This is illustrated at step 210. At this step in the process the training data 130 is processed through the classifier 110. The classifier 110 reports on the results of each of the training data sets. The process to train the classifier 110 can be any training process available.

The results of the classifier 110 are then passed through the scorer 120. This is illustrated at step 220. At this step the scorer 120 can calculate the likelihood that the classifier 110 has produced the correct result. Alternatively, the scorer 120 is configured to identify the portion of the results that caused the classifier 110 to classify the result in the manner that it did. This score can be represented either by a raw number or can be an indication of the confidence in the determined result.

The training data 130 is further passed to the feature identifier 140 to identify features in the training data 130 that can be used in validating the training of the classifier 110. This is illustrated at step 230. It should be noted that step 230 can be performed before, after, or at the same time as steps 210 and 220 above. In some embodiments instead of using the training data 130 the feature identifier 140 can use a different data set, such as the first data set to identify features for validating the classifier 110. In some embodiments the feature identifier 140 uses auto-validation features as the selected features. The tags/features that are identified may not be useful for the training of the classifier 110, but may affect the learning of the classifier 110. However, these tags can be useful for validating the classifier 110. To identify these tags/features different analysis of the data set can be done depending on the type of data that is used for the training data 130. In some embodiments the feature identifier 140 also considers metadata associated with the training data 130. This metadata can also be used as tags for identifying candidate data for use in validation.

The feature identifier 140 then passes these identified features to the rule generator 150 to identify data slices that can be used to validate the classifier 110. This is illustrated at step 240. The rule generator 150 takes that training data 130 and identifies a set of candidates from the training data 130 to determine if they should be considered for a data slice 160. As discussed above this subset of the training data 130 can be data points that the classifier 110 misclassified, or can be selected from the training data 130 based on other approaches. The rule generator 150 then determines if the particular feature is significant or not. In some embodiments the rule generator 150 uses linear separation between the data to determine if the feature is significant. If the feature is significant the rule generator 150 creates a data slice 160 based on that feature. The rule generator 150 can create a single data slice 160 or can create multiple data slices for a particular feature.

Once the rule generator 150 has generated the data slice 160, this data slice 160 is then passed back through classifier 110. This is illustrated at step 250. At this time the data slice 160 is processed through the classifier 110 with the intent of validating a particular rule that is applied by the classifier 110. Using this validation approach a user or other system reviews the results from each of the processed data slices and makes adjustments to the rules used by the classifier 110 to cause the classifier 110 to report correctly on each of the inputted data sets. This is illustrated at step 260

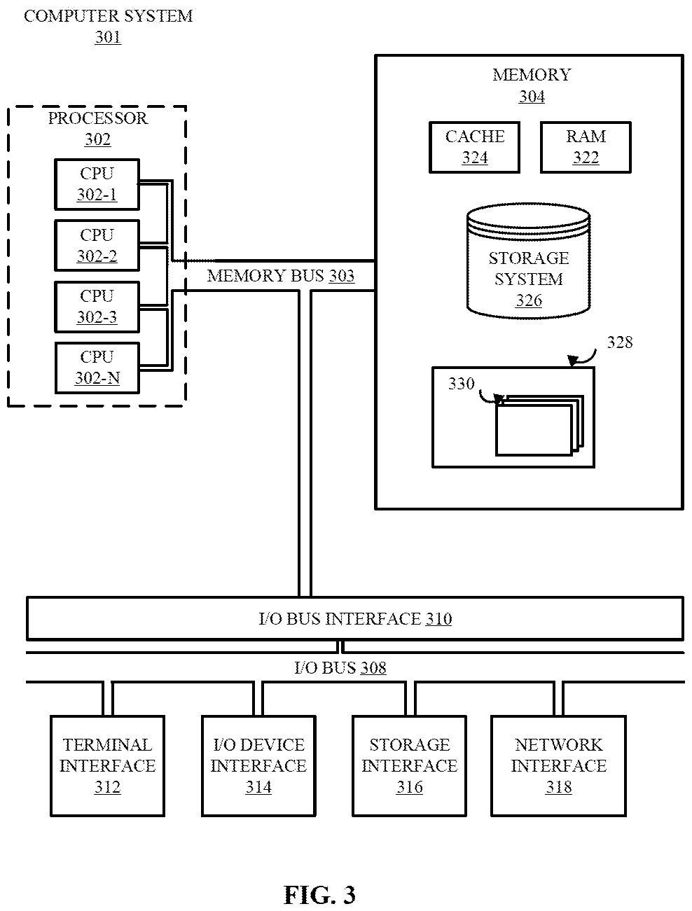

Referring now to FIG. 3, shown is a high-level block diagram of an example computer system 301 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 301 may comprise one or more CPUs 302, a memory subsystem 304, a terminal interface 312, a storage interface 316, an I/O (Input/Output) device interface 314, and a network interface 318, all of which may be communicatively coupled, directly or indirectly, for inter-component communication via a memory bus 303, an I/O bus 308, and an I/O bus interface unit 310.

The computer system 301 may contain one or more general-purpose programmable central processing units (CPUs) 302A, 302B, 302C, and 302D, herein generically referred to as the CPU 302. In some embodiments, the computer system 301 may contain multiple processors typical of a relatively large system; however, in other embodiments the computer system 301 may alternatively be a single CPU system. Each CPU 302 may execute instructions stored in the memory subsystem 304 and may include one or more levels of on-board cache.

System memory 304 may include computer system readable media in the form of volatile memory, such as random access memory (RAM) 322 or cache memory 324. Computer system 301 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the CPUs 302, the memory subsystem 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 301 may, in some embodiments, contain multiple I/O bus interface units 310, multiple I/O buses 308, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 301 may be a multi-user mainframe computer system, a single-user system, or a server computer or similar device that has little or no direct user interface, but receives requests from other computer systems (clients). Further, in some embodiments, the computer system 301 may be implemented as a desktop computer, portable computer, laptop or notebook computer, tablet computer, pocket computer, telephone, smart phone, network switches or routers, or any other appropriate type of electronic device.

It is noted that FIG. 3 is intended to depict the representative major components of an exemplary computer system 301. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

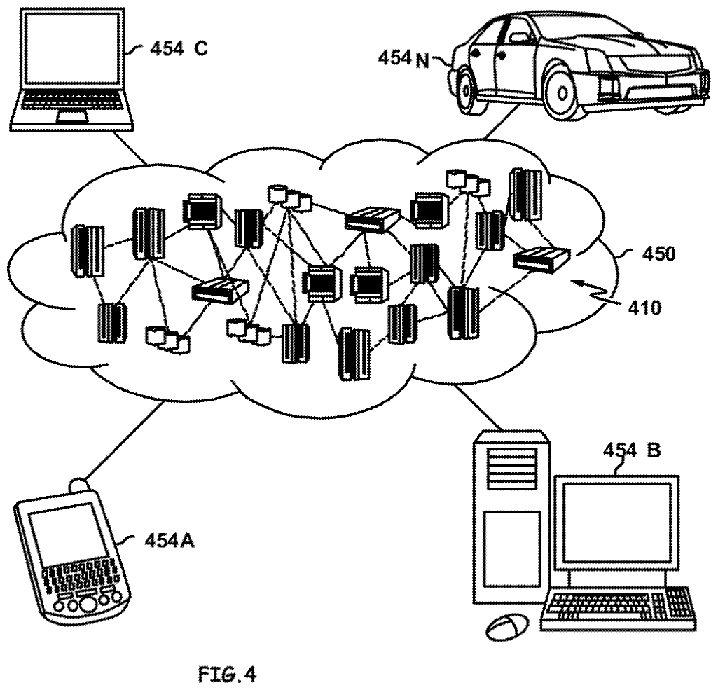

The system 100 may be employed in a cloud computing environment. FIG. 4, is a diagrammatic representation of an illustrative cloud computing environment 450 according to one embodiment. As shown, cloud computing environment 450 comprises one or more cloud computing nodes 454 with which local computing devices used by cloud consumers, such as, for example, personal digital assistant (PDA) or cellular telephone 454A, desktop computer 454B, laptop computer 454C, and/or automobile computer system 454N may communicate. Nodes 454 may communicate with one another. They may be grouped (not shown) physically or virtually, in one or more networks, such as Private, Community, Public, or Hybrid clouds as described hereinabove, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 454 and cloud computing environment 450 may communicate with any type of computerized device over any type of network and/or network addressable connection (e.g., using a web browser).

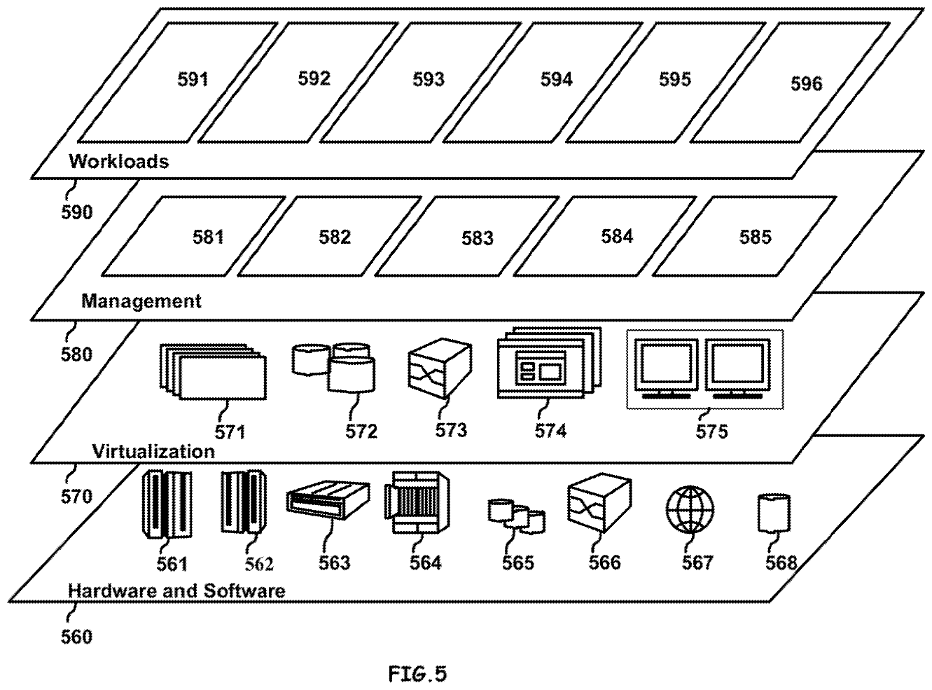

Referring now to FIG. 5, a set of functional abstraction layers provided by cloud computing environment 450 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; layout detection 593; data analytics processing 594; transaction processing 595; and database 596.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for generating data slices for validating a machine learning algorithm, comprising:
a classifier configured to classify a data set according to a set of rules;
a scorer configured to calculate a likelihood that the classifier has produced a correct result;
a feature identifier configured to identify features in the data set that can be used for validating the classifier; and
a rule generator configured to identify a data subset of the data set that can be used to validate the classifier based on the features identified by the feature identifier as a data slice.

2. The system of claim 1 wherein the classifier uses the machine learning algorithm.

3. The system of claim 1 wherein the data set is a training data set.

4. The system of claim 1 wherein the rule generator is configured to use a random forest model to identify the data subset.

5. The system of claim 1 wherein the rule generator is configured to determine if a feature identified by the feature identifier is a significant feature.

6. The system of claim 5 wherein the rule generator only generates a data slice for the significant feature.

7. The system of claim 1 wherein the rule generator passes the data slice to the classifier to generate a result on the data slice.

8. The system of claim 1 wherein the feature identifier identifies features that are not useful for training the classifier.

9. The system of claim 1 wherein the identified features include metadata on the data set.

10. The system of claim 1 wherein the feature identifier uses auto validation features.

11. A method for validating a classifier, comprising:
training the classifier using a machine learning algorithm;
passing a data set through the classifier to obtain results;
scoring the results to determine a likelihood the classifier correctly classified the data set;
identifying features in the data set that can be used to validate the classifier;
identifying at least one data slice in the data set based on the identified features; and
validating the classifier using the at least one data slice.

12. The method of claim 11 further comprising:
adjusting rules used by the classifier based on results from the classifier based on the at least one data slice.

13. The method of claim 11 wherein the data set is a training data set used to train the classifier.

14. The method of claim 11 wherein the features are auto validation features.

15. The method of claim 11 wherein the features include meta data in the data set.

16. The method of claim 11 wherein identifying the at least one data slice further comprises:
determining that an identified feature is a significant feature; and
creating the at least one data slice when the identified feature is significant.

17. The method of claim 11 where the at least one data slice includes only data from the data set that was misclassified by the classifier.

18. A system for validating a machine learning algorithm, comprising:
at least one processor;
at least one memory component;
a machine learning algorithm executing on the at least one processor, wherein the machine learning algorithm is trained using a training data set configured to cause the machine learning algorithm to produce a particular result.
a feature identifier configured to identify features in the data set that can be used for validating the machine learning algorithm; and
a rule generator configured to identify a data subset of the data set that can be used to validate the machine learning algorithm based on the features identified by the feature identifier as a data slice.

19. The system of claim 18 wherein the rule generator is configured to determine if a feature identified by the feature identifier is a significant feature.

20. The system of claim 18 wherein the feature identifier identifies features that are not useful for training the machine learning algorithm.
